(19) United States
(12) Patent Application Publication
(10) Pub. No.: US 2006/0047069 A1
(43) Pub. Date: Mar. 2, 2006

(54) Polymer dispersions having improved polyene-fungicide tolerance, their production and use for food coating

(75) Inventors: Martin Jakob, Kelkheim (DE); Heinrich Harrer, Krefeld (DE)

Correspondence Address: CONNOLLY BOVE LODGE & HUTZ, LLP, P O BOX 2207, WILMINGTON, DE, 19899, US

(73) Assignee: Celanese Emulsions GmbH, Kronberg/Ts. (DE)

(21) Appl. No.: 11/213,483

(22) Filed: Aug. 26, 2005

(30) Foreign Application Priority Data
Sep. 1, 2004 (DE) 10 2004 042 221.4

(51) Int. Cl. C08F 116/06

(52) U.S. Cl. 525/56

(57) ABSTRACT

A description is given of an aqueous polymer dispersion which is set to a pH range of 4 to 6 and comprises A) 100 parts by weight of a homopolymer or copolymer produced by emulsion polymerization, B) 0.1 to 15 parts by weight, based on the total amount of the monomers used, of at least one protective colloid, C) 0.1 to 10 parts by weight, based on the total amount of the monomers used, of at least one nonionic emulsifier, D) 10 to 990 ppm by weight, based on the mass of the total dispersion of at least one antioxidant, and E) at least one polyene fungicide. A second variant of the aqueous polymer dispersions is set to a pH range of 4.5 to 5.5 and has components A) to C) and E) but no antioxidant. The protective colloid of the aqueous polymer dispersions has no cellulose ether, or up to 0.45 part by weight of cellulose ether, based on the total amount of the monomers used. The polymer dispersions described are distinguished by excellent polyene-fungicide tolerance and may be used for coating foods.

The present invention relates to improved polymer dispersion based on copolymer poly(vinyl ester)s and other monomer bases for coating foods, which polymer dispersions are distinguished by an improved polyene-fungicide tolerance.

The use of polymer dispersions for coating foods, in particular hard cheese and meat products, has long been known. In the case of the hard-cheese coating, the dispersions are used as aids for controlled cheese ripening. The surface treatment and the subsequent drying of the dispersion generates a gas-permeable water vapor-barrier film which prevents not only mold formation on the cheese, but also too-rapid drying out of the cheese loaf during ripening. During the ripening process, the cheeses pass through storage lasting for a plurality of weeks to months in moist rooms. The unwanted growth of microorganisms, principally molds and yeasts, is counteracted by an antimicrobial, in particular antifungicidal, finishing of the dispersions with special polyene fungicides such as natamycin (pimaricin).

Natamycin is a polyene macrolide having high fungicidal activity which can be isolated from the culture substrate of Streptomyces natalensis. It is a white crystalline powder without characteristic taste or odor. It is soluble in a variety of organic solvents, but is customarily applied as an aqueous suspension to the food coating composition, since the water solubility at 0.005 percent by weight is relatively low.

A characteristic of natamycin, as also the various other polyene fungicides, is its chemical instability. Natamycin has reactive functional groups at which the molecule can readily be reacted or, by bond breakage, fragmented. The secondary products generally have little if any microbiological activity. The breakdown proceeds not only in homogeneous solution, but also in the form of the aqueous suspension. Substances or influences which lead to a breakdown of natamycin activity have been described, for example, by H. Brik in Analytical Profiles of Drug Substances 10, 513-561 (1980). These include extremely acidic or basic pH values, high temperature, UV or gamma radiation, atmospheric oxygen, peroxides, metal ions such as Fe(III), Ni(II) or Cr(III), or the presence of sulfites or sodium formaldehyde sulfoxylate.

For the distributor of polymer-dispersion-based food coating compositions finished with polyene fungicides, owing to the very high price of the commercial forms of the biocide, it would be desirable if there were a dispersion composition which has a high biocide tolerance, that is to say which contributes as little as possible to the breakdown with time of the active compound. Since, frequently, the manufacturers of the coating compositions guarantee minimum concentrations or minimum times for an antifungicidal activity, costs may be reduced by omitting a calculated safety margin of expensive excess biocide.

Apart from the described effects and the obvious chemical deactivators such as metal ions or peroxides, the interaction between the polymeric or low-molecular-weight components present in a polymer latex and the chemical properties of the latex surfaces on the one hand, and the natamycin customarily applied in suspension form on the other, is completely unclear. Polymer dispersions of one and the same monomer basis can have completely different fungicide tolerances.

In the prior art there have been various approaches to stabilizing natamycin in systems which comprise an aqueous phase.

U.S. Pat. No. 5,738,888 describes a drink which is preserved by a combination of natamycin and dimethyl dicarbonate. The presence of antioxidants or oxygen scavengers increases the natamycin stability. This is preferably achieved by the ascorbic acid present in the drinks. The same effect is also achieved by complexing agents such as EDTA, polyphosphoric acid or the naturally occurring citric acid, which bind free heavy metal ions or polyvalent ions and prevent attack on the biocide. The pH range of the claimed drinks is between 2 and 6.5.

Indications of antioxidant stabilization of natamycin in connection with foods are found in other publications, for instance in U.S. Pat. No. 5,895,680, U.S. Pat. No. 5,895,681, U.S. Pat. No. 6,146,675 and U.S. Pat. No. 6,156,362. However, in none of the abovementioned publications is the use or stabilization of natamycin in a polymer dispersion mentioned.

WO-A-01/45,513 describes a process for maintaining the activity of natamycin in an aqueous solution, in which the solution is provided with a chelating agent and/or an antioxidant. The chelating agent and the antioxidant can be the same composition or different compositions. Typical chelating agents are glycine, polyphosphate, EDTA, a salt of EDTA, 1,3-diamino-2-hydroxypropane-N,N,N′,N′-tetraacetic acid or 1,3-diaminopropane-N,N,N′,N′-tetraacetic acid; typical antioxidants are ascorbic acid, citric acid, butylated hydroxyanisole, butylated hydroxytoluene, a gallate, a tocoferol, ascorbyl palmitate and/or calcium ascorbate. The aqueous solutions can also comprise latex particles. Example 3 shows, for the example of the dispersion ®Mowilith DM2KL, that apparently the best recovery of the biocide occurs in the case of stabilization of the dispersion using protective colloids.

The publication further discloses in its examples 4, 5 and 9 the addition of the antioxidants ascorbic acid, citric acid, butylated hydroxyanisole and tocopherol to improve the time-dependent residual activity of natamycin. The amounts of the antioxidants used are at least 1000 ppm. The dispersions are set in advance to a pH of 5±1 using ammonia. The polymer dispersions described in the examples, owing to the use of Mowilith® DM2KL, comprise relatively high amounts of cellulose ether as protective colloid, or the polymer dispersions do not comprise protective colloid, but are predominantly stabilized by anionic emulsifiers.

In particular for producing the homopolymers and copolymers of vinyl esters, for example vinyl acetate, which are frequently used as polymer base for food-coating systems, according to PL-B-172,130, it has been found to be expedient to work with mixed stabilizing systems, poly(vinyl alcohol) and cellulose ether and/or emulsifiers being used simultaneously as protective colloids.

However, in current production practice, the problem occurs that even in the case of dispersions predominantly stabilized with protective colloid, inexplicable variations of the biocide tolerance occur. These are not due to the presence of heavy metal ions or residual peroxides and may be cushioned only to a limited extent by adding antioxidants.

The solution proposed in WO-A-01/45,513 is not applicable, or would, even in the case of an activity, owing to the comparatively high required amounts of >1000 ppm of stabilizing additives and the associated disadvantages (for example higher yellowing in the case of ascorbic acid) only partially satisfy the requirements made here.

U.S. Pat. No. 3,390,109 discloses alkali-resistant terpolymer compositions which are suitable as binders for dispersion dyes or as additives in compositions set in hydraulically. In this publication, there is given neither an indication of the use of polyene fungicides, nor of the use of antioxidants. This is also not necessary, since the described fields of use do not require the use of these additives.

EP-A-678,241 describes suspensions of polyene fungicides which are stabilized by addition of thickeners. Polymer dispersions are not mentioned in this publication.

The object underlying the present invention was therefore to provide suitable polymer dispersions for producing food coating systems, which polymer dispersions have improved polyene biocide tolerance, in particular toward natamycin, compared with conventional dispersions.

Surprisingly, it has now been found that this object is achieved by polymer dispersions which are produced by means of selected amounts of a mixed stabilizing system which utilizes a protective colloid system which comprises either no or only limited amounts of cellulose ether, the dispersions comprise low amounts of antioxidants and are set in a selective pH range.

The present invention thus relates to an aqueous polymer dispersion set to a pH range of 4 to 6, preferably 4.2 to 5.5, comprising
A) 100 parts by weight of a homopolymer or copolymer produced by emulsion polymerization,
B) 0.1 to 15 parts by weight, preferably 0.2 to 10 parts by weight, based on the total amount of the monomers used, of at least one protective colloid, preferably poly(vinyl alcohol),
C) 0.1 to 10 parts by weight, preferably 0.1 to 3.0 parts by weight, based on the total amount of the monomers used, of at least one nonionic emulsifier,
D) 10 to 990 ppm by weight, based on the mass of the total dispersion of at least one antioxidant, and
E) at least one polyene fungicide
   with the proviso that the protective colloid contains no cellulose ether, or up to 0.45 parts by weight of cellulose ether, based on the total amount of the monomers used.

The amount of cellulose ether or mixture of different cellulose ethers in the components B) of the inventive polymer dispersion is 0 to 0.45 parts by weight, preferably 0 to 0.3 parts by weight, based on the total amount of the monomers used. Particularly preferably, the inventive polymer dispersion does not comprise cellulose ether.

The fraction of antioxidant D) or mixture of different antioxidants D) in the inventive polymer dispersion is 10 to 990 ppm, preferably 50 to 900 ppm, particularly preferably 100 to 500 ppm and very particularly preferably 100 to 350 ppm, based on the mass of the total dispersion.

In a further embodiment, the invention relates to an aqueous polymer dispersion having a defined pH range. This polymer dispersion also exhibits, without the presence of antioxidants, a surprisingly high polyene-fungicide tolerance, in particular toward natamycin.

The invention therefore also relates to an aqueous polymer dispersion which is set to a pH range of 4.5 to 5.5, preferably of 4.6 to 5.2, comprising
A) 100 parts by weight of a homopolymer or copolymer produced by emulsion polymerization,
B) 0.1 to 15 parts by weight, based on the total amount of the monomers used, of at least one protective colloid,
C) 0.1 to 10 parts by weight, based on the total amount of the monomers used, of at least one nonionic emulsifier, and
E) at least one polyene fungicide
   with the proviso that the polymer dispersion is free of antioxidant and that the protective colloid has no cellulose ether or up to 0.45 part by weight of cellulose ether, based on the total amount of the monomers used.

The fraction of polyene fungicide E) or, of mixture of various polyene fungicides E) in the inventive polymer dispersion is typically 50 to 1000 ppm, preferably 100 to 500 ppm, particularly preferably 100 to 400 ppm, and very particularly preferably 150 to 350 ppm, based on the mass of the total dispersion.

The inventive polymer dispersions comprise, if appropriate, other additives F) suitable for coating foods. Their fraction is typically up to 25 parts by weight, preferably 0.1 to 20 parts by weight, based on the mass of the total dispersion.

As homopolymers or copolymers A), use may be made of any compounds derived from monomers which can be polymerized by a free-radical mechanism.

In a preferred embodiment, the following homopolymers or copolymers A) form, via their chief monomers, the basis of the inventive dispersion:
A1) a copolymer of the vinyl esters of aliphatic, saturated carboxylic acids, preferably fatty acids having a chain length of C₁-₁₈, and maleic esters and/or fumaric esters of monohydric aliphatic alcohols having a chain length of C₁-₁₈,
A2) a homopolymer or copolymer of vinyl esters of aliphatic, saturated carboxylic acids, preferably fatty acids having a chain length of C₁-₁₈,
A3) a copolymer of vinyl esters of aliphatic, saturated carboxylic acids, preferably fatty acids having a chain length of C₁-₁₈ and alpha-olefins having 2 to 8 carbon atoms, in particular ethylene,
A4) a homopolymer or copolymer of (meth)acrylic acid alkyl esters having 1 to 18 carbon atoms in the alkyl chain, or a copolymer of these (meth)acrylic acid alkyl esters having any combinations of the monomers specified under A1) to A3).

The vinyl esters of aliphatic saturated carboxylic acids of chain length C₁-C₁₈ of the copolymer A1), A2) and A3) are, for example, vinyl formate, vinyl acetate, vinyl propionate, vinyl butyrate, vinyl isobutyrate, vinyl pivalate, vinyl 2-ethylhexanoate, vinyl esters of α-branched carboxylic acids having 9 to 11 carbon atoms in the acid radical (®Versatic acids), and also the vinyl esters of lauric, palmitic, myristic and stearic acids.

The use of the vinyl esters of aliphatic fatty acids is preferred, including, in particular, vinyl acetate. The vinyl esters of the copolymer A1), A2) and A3) can also be present in combination of two or more thereof simultaneously.

Particularly preferably, the vinyl esters of group A1) are used.

The maleic and fumaric esters of monohydric aliphatic alcohols of chain length C₁-C₁₈ of the copolymer A1) are those of saturated alcohols of chain length C₁-C₁₈ or those of monohydric aliphatic unsaturated alcohols of chain length C₃-C₁₈, but preferably those with saturated alcohols of chain length C₄-C₈, in particular dibutyl maleate or di-2-ethylhexyl maleate and/or fumarate. The use of dibutyl maleate and/or fumarate is particularly preferred.

The alpha-olefins having 2 to 8 carbon atoms of the copolymer A3) are branched or straight-chain alpha-olefins, for example prop-1-ene, but-1-ene, pent-1-ene, hex-1-ene, hept-1-ene, oct-1-ene and, in particular ethylene.

The (meth)acrylic acid alkyl esters of the copolymer A4) are (meth)acrylic acid alkyl esters having 1 to 18 carbon atoms in the alkyl chain. The acrylates are typically esters of acrylic acid with alcohols, such as in particular methanol, ethanol, n-butanol, isobutanol or 2-ethylhexanol. Preferred monomers of this type are methyl, ethyl, n-butyl, isobutyl and 2-ethylhexyl esters of acrylic acid. The methacrylates are typically esters of methacrylic acid with alcohols, such as in particular methanol, ethanol, n-butanol, isobutanol or 2-ethylhexanol. Preferred monomers of this type are methyl, ethyl, n-butyl, isobutyl and 2-ethylhexyl esters of methacrylic acid.

The abovementioned copolymers A1) to A4), to set specific properties and for additional stabilization, can comprise other comonomers. For this any comonomers may be used which do not belong to the groups A1), A2), A3) or A4).

Examples of these are esters of ethylenically unsaturated aliphatic mono- and/or dicarboxylic acids with polyalkylene glycols, preferably with polyethylene glycols and/or polypropylene glycols, or esters of ethylenically unsaturated carboxylic acids with amino alcohols, such as (meth)acrylic esters of amino alcohols, for example of diethylaminoethanol, and/or (meth)acrylic esters with dimethylaminoethanol, and also (meth)acrylic esters with dihydric aliphatic alcohols of chain length C₂-C₁₈ in which only one alcohol group is esterified. In addition, amides of ethylenically unsaturated carboxylic acids, such as amides of acrylic and methacrylic acid and N-methylolamides of acrylic and methacrylic acid and also ethers thereof are suitable. A further group of these monomers are N-vinylamides, including the N-vinyllactams, for example vinylpyrrolidone, or N-vinyl-N-methylacetamide.

In addition, use may be made of ethylenically unsaturated carboxylic acids or sulfonic acids which have one or two carboxyl groups or a sulfonic acid group. Instead of the free acids, use can also be made of their salts, preferably alkali metal or ammonium salts. Examples of these are acrylic acid, methacrylic acid, crotonic acid, maleic acid, fumaric acid, itaconic acid, vinylsulfonic acid, styrenesulfonic acid, half esters of maleic or fumaric acid and itaconic acid with monohydric aliphatic saturated alcohols of chain length C₁-C₁₈ and also their alkali metal and ammonium salts or (meth)acrylic esters of sulfoalkanols, for example sodium 2-sulfoethyl methacrylate. Particularly suitable are half esters of maleic or fumaric acid and itaconic acid with monohydric aliphatic saturated alcohols of chain length C₁-C₁₈, and also of their alkali metal and ammonium salts.

Further examples of comonomers which may be used are esters of aliphatic carboxylic acids of chain length C₃-C₁₂ with unsaturated alcohols of chain length C₃-C₁₈, vinyl chloride, vinylidene chloride, acrylonitrile and methacrylonitrile, butadiene, isoprene, C₉-C₁₆ alpha-olefins, 2-chlorobutadiene, 2,3-dichlorobutadiene, tetrafluoroethylene, styrene, vinyl ethers of monohydric aliphatic saturated alcohols of chain length C₁-C₁₈, divinyl and diallyl esters of saturated and unsaturated aliphatic dicarboxylic acids of chain length C₃-C₁₈, vinyl and allyl esters of acrylic acid and crotonic acid and triallyl cyanurate.

The amount of these monomers in the copolymers A1) to A4), if appropriate in combination with further comonomers from this monomer group, is typically 0 to 15% by weight, preferably 0 to 10% by weight, in each case based on the sum of the monomers used.

As protective colloid B), that is to say as polymeric stabilizer, suitable compounds are poly(vinyl alcohol), gelatin, casein, starch, gum Arabic, modified starches such as hydroxyethyl starch, sodium alginate, and also homo- or copolymers having monomer units derived from the monomers specified in the groups of the polymers A1) to A4), e.g. vinyl esters, (meth)acrylic acids and/or (meth)acrylic esters, and also N-vinylamides, including the N-vinyllactams and/or the water-soluble salts of these homo- or copolymers. Examples of (meth)acrylic acids are polyacrylic acid and/or polymethacrylic acid. Examples of N-vinylamides are polyvinylpyrrolidone and N-vinylacetamide.

The preferred protective colloid B) is polyvinyl alcohol.

Suitable poly(vinyl alcohol) has degrees of hydrolysis of 60 to 100 mol % and viscosities of the 4% strength aqueous solutions at 20° C. of 2-70 mPa·s.

The term “poly(vinyl alcohol)” within the meaning of the invention comprises in the broadest sense formal copolymers of vinyl alcohol with other monomer units, with these not being explicitly limited to vinyl acetate units in partially saponified poly(vinyl alcohol)s.

Examples of such compounds are copolymers of vinyl alcohols with isopropenyl alcohol or isopropenyl acetate or with aldehydes such as formaldehyde or butyraldehyde reacted in a polymer-analog form, i.e. partially acetalized poly(vinyl alcohol)s.

In addition, it can be advantageous to use mixtures of poly(vinyl alcohol)s of various molecular weights and/or degrees of hydrolysis in order to be able to control the viscosity in a targeted manner, or as described in WO-A-03/54,041 to set properties in a targeted manner.

Said protective colloids can obviously also be used in the form of mixtures. If this is the case, use is preferably made of mixtures of poly(vinyl alcohol) and polyvinylpyrrolidone.

The amount of the protective colloids used, based on the copolymer A), is 0.1 to 1-5 parts by weight, preferably 0.2 to 10 parts by weight.

The cellulose ethers used if appropriate are typically known cellulose ether derivatives which are known to be used as protective colloids. Examples of these are hydroxyethyl-, methylhydroxyethyl-, methyl-, propyl-, sodium carboxy methyl-, allyl-, allylhydroxyethyl- or allylglycidylhydroxyethyl celluloses.

The amounts of these compounds used are to be considered as critical for both variants of the inventive polymer dispersions. In the context of the invention it has proved to be necessary to use at most 0.45 parts by weight, preferably 0 to 0.3 parts by weight, based on 100 parts of the total amount of the monomers used.

It is particularly preferred if no cellulose ethers are used in the protective colloid system.

Suitable nonionic emulsifiers C) are, in particular, acyl, alkyl-, oleyl and alkylaryl oxethylates. These products are obtainable, for example, commercially under the name Genapol® or Lutensol®. These include, for example, ethoxylated mono-, di- and trialkylphenols (EO degree: 3 to 50, alkyl substituent radical: C₄ to C₁₂) and also ethoxylated fatty alcohols (EO degree: 3 to 80; alkyl radical: C₈ to C₃₆), especially C₁₂-C₁₄-fatty alcohol(3-8)ethoxylates, C₁₃C₁₅-oxoalcohol(3-30)ethoxylates, C₁₆C₁₈ fatty alcohol(1′-80)ethoxylates, C₁₀-oxoalcohol(3-11)ethoxylates, C₁₃-oxoalcohol(3-20)ethoxylates, polyoxyethylene sorbitan monooleate having 20 ethylene oxide groups, copolymers of ethylene oxide and propylene oxide having a minimum content of 10% by weight ethylene oxide, the polyethylene oxide(4-20)ethers of oleyl alcohol and also polyethene oxide(4-20)ethers of nonylphenol. Those which are particularly suitable are the polyethylene oxide(4-20)ethers of fatty alcohols, in particular of oleyl alcohol. Of nonionic emulsifiers, use is made of 0.1 to 10 parts by weight, preferably 0.5 to 5.0%, based on the copolymer A). Mixtures of nonionic emulsifiers may also be used.

For further improvement of the stability, it is also possible to use conjointly other, in this case ionic, preferably anionic, stabilizers as co-emulsifier.

Examples which may be mentioned are sodium, potassium and ammonium salts of straight-chain aliphatic carboxylic acids of chain length C12-C20, sodium hydroxyoctadecane sulfonate, sodium, potassium and ammonium salts of hydroxy fatty acids of chain length C12-C20 and their sulfation and/or acetylation products, alkylsulfates, also as triethanolamine salts, alkyl(C10-C20) sulfonates, alkyl(C10-C20) arylsulfonates, dimethyl dialkyl(C8-C18) ammonium chloride and their sulfation products, alkali metal salts of sulfosuccinic esters with aliphatic saturated monohydric alcohols of chain length C4-C16, sulfosuccinic acid 4-esters with polyethylene glycol ethers of monohydric aliphatic alcohols of chain length C10-C12 (disodium salt), sulfosuccinic acid 4-esters with polyethylene glycol nonylphenyl ethers (disodium salt), sulfosuccinic acid bis-cyclohexyl esters (sodium salt), lignosulfonic acid and also its calcium, magnesium, sodium and ammonium salts, resin acids, hydrogenated and dehydrogenated resin acids and also their alkali metal salts, dodecylated diphenyl ether disulfonic acid sodium salt, and also sodium lauryl sulfate, or ethoxylated sodium lauryl ether sulfate (EO degree 3). Mixtures of ionic emulsifiers may also be used.

The amount of component C), based on 100 parts by weight of monomers of the copolymer group A), is 0.1 to 10 parts by weight, preferably 0.1 to 5 parts by weight, in particular 0.1 to 3.0 parts by weight.

Additional ionic emulsifiers present, if appropriate, are used in excess, with respect to the nonionic emulsifiers. Typically, the fraction of ionic emulsifiers, based on the total amount of the emulsifiers used, is up to 40% by weight, preferably less than 10% by weight.

Particularly preferably, in addition to nonionic emulsifiers C), no further ionic emulsifiers are used.

Component D) in the first variant of the inventive polymer dispersion is an antioxidant or a mixture of antioxidants. Among these are taken to be compounds which, in the pH range set, have a redox potential of <0 mV, preferably <200 mV.

Preferred components D) are ascorbic acid, its precursors and/or derivatives (such as esters or salts), hydroxycarboxylic acids or their derivatives (such as their esters or salts) and/or substituted phenols. Examples of particularly preferred components D) are ascorbic acid, isoascorbic acid, tartaric acid or citric acid, the alkali metal or alkaline earth metal salts of these acids, gluconic acid, ascorbyl palmitate, ascorbyl stearate, butylated hydroxyanisole, butylated hydroxytoluene, alpha-tocopherol, gamma-tocopherol or delta-tocopherol, retinol, propyl, octyl or dodecyl gallate.

The inventive dispersions have, if appropriate, other additives (F) suitable for the production of food coating compositions. These include, for example, compounds which are suitable as thickeners.

Primarily, here, again mention must be made of poly(vinyl alcohol) and cellulose ethers which are additionally added to the compounds used as protective colloid after completion of polymerization, or preferably after demonomerization, for setting a suitable application viscosity. Although the post-added cellulose ether influences the polyene-fungicide tolerance less than that used as protective colloid, the type and amount of these additives must be tested by measuring the recovery rates of the polyene fungicide.

Further additives F) are, for example, all compounds specified under B).

Suitable additives F) are obviously also low-molecular-weight substances such as urea, boric acid, stabilizers such as neutralizing agent and complexing agent.

The amounts used of the first mentioned are determined by the pHs to be maintained in the context of this invention. Those which may be mentioned by way of example for this group of additives are alkali metal, ammonium, calcium hydroxides, alkali metal, ammonium, calcium carbonates, alkali metal, ammonium, calcium phosphates, alkaline metal salts of ethylenediaminetetraacetic acid and N-hydroxy-ethylethylenediaminetriacetic acid, and also sodium acetate and phosphoric acid, formic acid, ammonium chloride, sodium sulfate, homopolymers of 2-acrylamido-2-methylpropanesulfonic acid and their sodium, potassium and ammonium salts.

In addition, additives of group F) comprise other preservatives which are permitted in the relevant regulations under food law on additives for cheese or other foods to be coated. Examples of these are free sorbic acid and benzoic acid, their salts and derivatives of p-hydroxybenzoic acid.

Another group is formed by the food additive colorings permitted in the relevant positive lists, such as carotene (E 160a), annato (E 160b), Carbo Medicinalis vegetabilis [Medical Vegetable Carbon] (E 153), titanium dioxide (E 171), tartrazine (E 102), quinoline yellow (E 104), sunset yellow FCF (E 110), cochenille red A (E 124), indigotine (E 132), brilliant black BN (E 151) or lithol rubine BK (E 180).

The inventive polymer dispersions have, as component E), a polyene fungicide or a mixture of polyene fungicides. These preferably include natamycin. However, chemically similar biocides can also be used. Examples of these are lucensomycin, arenomycin B, tetramycin, tetrin A, tetrin B, amphotericin B and/or nystatin. As a result of the physical characteristics of the inventive polymer dispersions a uniformly high polyene-fungicide tolerance, in particular a high natamycin tolerance, is achieved. This is expressed in constantly high recovery rates of the biocide as a function of time.

The first variant of the inventive polymer dispersions is set in a pH range between 4 and 6. This pH range can already be present after polymerization, or it is set by subsequent addition of the abovementioned aids F).

The second variant of the inventive polymer dispersions is set in a pH range between 4.5, and 5.5. This pH range can likewise already be present after polymerization, or it is set by subsequent addition of the abovementioned aids F).

A particularly preferred range for the first variant is between 4.2 and 5.5.

A particularly preferred range for the second variant is between 4.6 and 5.2.

The invention also relates to the preproducts of the compositions of variant 1. These are compositions comprising components A), B), C) and D).

The solids content of the inventive aqueous polymer dispersions is 20 to 70% by weight, preferably 30 to 65% by weight, and particularly preferably 40 to 60% by weight.

The minimum film-forming temperature of the inventive polymer dispersions is typically below 25° C., preferably below 15° C. The minimum film-forming temperature can be modified and set in a targeted manner by addition of coalescents known per se.

The invention further relates to a process for producing the inventive polymer dispersions by means of free-radical emulsion polymerization.

The procedure of a free-radical-initiated aqueous emulsion polymerization of ethylenically unsaturated monomers has been previously described many times and is therefore adequately known to those skilled in the art [see, e.g. Encyclopedia of Polymer Science and Engineering, Vol. 8, pages 659 to 677, John Wiley & Sons, Inc., 1987].

The invention relates to a process for producing the first variant of aqueous polymer dispersions comprising the steps:
i) free-radical emulsion polymerization of at least one ethylenically unsaturated monomer for producing a homopolymer or copolymer A) in the presence of ii) 0.1 to 15 parts by weight, preferably 0.2 to 10 parts by weight, of at least one protective colloid, preferably poly(vinyl alcohol), and
iii) 0.1 to 10 parts by weight, preferably 0.1 to 3.0 parts by weight, of at least one nonionic emulsifier,
iv) if appropriate, addition of at least one antioxidant in an amount such that the concentration of antioxidant in the polymer dispersion is 10-990 ppm by weight, based on the mass of the total dispersion,
v) if appropriate, setting the resultant aqueous polymer dispersion to a pH range between 4 and 6,
vi) if appropriate, addition of further additives F) suitable for coating foods, and
vii) addition of polyene fungicide,
   with the proviso that the protective colloid used has no cellulose ether, or up to 0.45 parts by weight of cellulose ether, based on the total amount of the monomers used.

The invention further relates to a process for producing the second variant of aqueous polymer dispersions comprising the steps:
i) free-radical emulsion polymerization of at least one ethylenically unsaturated monomer for producing a homopolymer or copolymer A) in the presence of ii) 0.1 to 15 parts by weight, preferably 0.2 to 10 parts by weight of at least one protective colloid, preferably poly(vinyl alcohol) and
iii) 0.1 to 10 parts by weight, preferably 0.1 to 3.0 parts by weight, of at least one nonionic emulsifier,
iv) if appropriate, addition of at least one antioxidant in an amount such that the content of unreacted monomers and/or oxidizing components in the polymer dispersion is decreased with reduction of the amount of antioxidant,
v) if appropriate, setting the resultant aqueous polymer dispersion to a pH range between 4.5 and 5.5,
vi) if appropriate, addition of further additives suitable for coating foods, and
vii) addition of polyene fungicide,
   with the proviso that the amount of antioxidant is chosen such that the polymer dispersion, after carrying out step iv) is free from antioxidants and that the protective colloid used has no cellulose ether, or up to 0.45 part by weight of cellulose ether, based on the total amount of the monomers used.

This polymerization can be carried out in the batch process, in the incremental-feed process, or the combined batch/incremental feed process or in continuous loop reactors or stirred-tank cascades.

Preferably, however, operations are carried out in the combined batch/incremental-feed process, or particularly preferably, in the incremental-feed process, with, customarily, a part of the monomers (1 to 15% by weight) being charged for starting the polymerization.

The monomers can be metered either together or in separate feeds. Furthermore, it can be advantageous, in certain embodiments, to carry out a seed polymerization for setting specific particle sizes and particle size distributions.

As free-radical initiators, use can be made of the customary compounds known for such polymerizations. Examples of these are: hydrogen peroxide, benzoyl peroxide, cyclohexanone peroxide, isopropylcumyl hydroperoxide, persulfates of potassium, sodium and ammonium, peroxides of even-numbered saturated monobasic aliphatic carboxylic acids of chain length C₈-C₁₂, tertiarybutyl hydroperoxide, ditertiarybutyl peroxide, diisopropyl percarbonate, azoisobutyrodinitrile, acetylcyclohexanesulfonyl peroxide, tertiarybutyl perbenzoate, tertiarybutyl peroctoate, bis-(3,5,5-trimethyl)-hexanoyl peroxide, tertiarybutyl perpivalate, hydroperoxypinane, p-methane hydroperoxide. The abovementioned compounds can also be used within a redox system, in which case reducing agents are used in conjunction. The reducing agents can be identical to the compounds (antioxidants) mentioned under D), or different. As reducing agents, in addition, use can be made in conjunction of alkali metal salts of hydroxymethylsulfinic acid, of sulfinatohydroxyacetic acid, hydroxylamine and salts of hydroxylamine, sodium bisulfite, sodium sulfite, ammonium bisulfite, sodium dithionite. In this case, however, in principle the sensitivity of natamycin to sulfur nucleophiles must be taken into account. The components of the initiator system or redox system can, in each case separately, or in combination, before the start of the polymerization be charged, metered, or partially charged and partially metered, or added in the form of portions.

Preferably, use is made of water-soluble persulfates, in particular ammonium persulfate or sodium persulfate or hydrogen peroxide, for starting the polymerization.

For controlling the molecular weight, substances, for example mercaptans of chain length C₁₀-C₁₄, but-(1)-en-(3)-ol, sodium dialkyldithiocarbamate or diisopropylxanthogen disulfide can be used conjointly in the polymerization.

The protective colloid or the protective colloids B) used for the stabilization, preferably the poly(vinyl alcohol), can, either at the start of the polymerization, be charged completely, or partially charged and partially metered, or can be completely metered during the polymerization, in which case, however, in a preferred embodiment the component B) is charged in advance completely.

The cellulose ether used, if appropriate, conjointly for stabilization can likewise either be charged completely at the start of the polymerization, or charged in part and metered in part during the polymerization, or be completely metered-in during the polymerization.

The nonionic emulsifier(s) used conjointly for stabilization, or the nonionic emulsifiers C) can likewise, either at the start of the polymerization, be charged in advance completely or charged in advance in part and metered in part, or be metered in completely during the polymerization. The same applies in principle to the conjoint use of one or more further ionic coemulsifiers.

The polymerization temperature typically ranges in the range from 20 to 120° C., preferably in the range from 30 to 110° C., and very particularly preferably in the range from 45 to 95° C.

After completion of the polymerization, for demonomerization and for removal of oxidizing constituents, there can follow a further, preferably chemical, aftertreatment, in particular using redox catalysts, for example combinations of the abovementioned oxidizing agents and reducing agents, in particular the inventive antioxidants specified under D). In addition, any residual monomer present can be removed in a known manner, for example by physical demonomerization, i.e. removal by distillation (in particular by steam distillation) or by stripping using an inert gas. A particularly efficient method is a combination of physical and chemical methods which permits a decrease of the residual monomers to very low contents (<1000 ppm, preferably <100 ppm).

After substantial completion of the polymerization, preferably after completion of the chemical and/or physical demonomerization and removal of oxidizing constituents, there follows the addition of the additives F) suitable for coating foods and, in the case of the first variant of the process, the addition of the inventively used antioxidant D). In the case of the second variant of the process, care must be taken to ensure that the polymer dispersion, after the demonomerization and removal of oxidizing constituents, no longer has antioxidant. This means that using customary detection methods, by which up to 10 ppm of antioxidant can be detected, no antioxidant can any longer be detected in the polymer dispersion. The sequence of the additions is not critical in principle, but should be designed for the compatibility of the components and in particular the end value of the pH to be set according to the invention. If, for example, an acid is added as antioxidant, the addition of an alkaline pH adjusting agent should be performed after this step. The addition of the antioxidant can then be omitted if a sufficient residual concentration of free antioxidant is already present from the polymerization and/or the chemical demonomerization. This is the case when very high stoichiometric excesses of antioxidant, based on the oxidizing agent, are used.

However, it has proved to be advantageous when the antioxidant or the antioxidants D) is/are added in the form of a defined supplementation, not until after substantial completion of the polymerization, preferably after completion of the chemical and/or physical demonomerization. This component is then generally added at a lower temperature than that which is used in the chemical demonomerization.

The inventive aqueous polymer dispersions lead, via their specific selection of substances, to a high polyene-fungicide tolerance. Owing to the extremely high price of these products, therefore, customarily, no safety margin or only a reduced safety margin, of polyene fungicide needs to be added to the inventive coating compositions. Also owing to the fact that expenditures to improve the polyene-fungicide resistance are no longer required, they lead to a significant cost saving.

Furthermore, owing to the significantly lower polyene-fungicide concentration, the risk of formation of resistant mold or yeast cultures is decreased, which otherwise lead to expensive decontamination processes when they occur in, e.g., production sites for hard cheese.

The polymer dispersions having the polyene fungicides, in particular finished using natamycin, are suitable not only as aids for cheese ripening, but also as coating compositions and/or as packaging material for foods of all types, in particular for meat products and sausage products, for vegetables, in particular stem vegetables, for fruits, preferably hard shell fruits, in particular citrus fruits, for seed material and for soft cheese.

Furthermore, they are suitable for producing coatings as aids in the production of foods, in particular of cheese or generally where the prevailing environmental conditions lead to an increased infestation of molds and yeasts.

These uses are likewise subject-matter of the present invention.

The examples hereinafter serve to illustrate the invention. The parts and percentages specified in the examples relate to the weight, where not stated otherwise.

Dispersion A

In a cylindrical glass stirred-tank reactor equipped with heating/cooling bath, anchor agitator, metering apparatuses and reflux condenser, 3.5 parts of ®Mowiol 40-88 and 3.5 parts of ®Mowiol 26-88 (partially saponified poly(vinyl alcohol) from Kuraray Specialties Europe of a degree of hydrolysis of 88 mol % and a mean viscosity of approximately 40 and 26 mPa·s, respectively, measured in 4% strength aqueous solution at 20° C.) and also 0.5 parts of ®Genapol 0-200 (ethoxylated oleyl alcohol from Clariant GmbH of a mean degree of ethoxylation of 20 mol of ethylene oxide), together with 0.11 parts of anhydrous sodium acetate, Were suspended in 115 parts of deionized water and then dissolved at a temperature of at least 80° C. This solution was cooled overnight to room temperature. Before the polymerization, 0.11 parts of glacial acetic acid were added and the experimental batch was heated. At 65° C., 5.7% of in total 100 parts of monomer mixture consisting of 70 parts of vinyl acetate and 30 parts of di-n-butylmaleate, were added in the course of 10 min to start the polymerization. The reaction was started by adding 0.2 parts of ammonium peroxodisulfate in 2.05 parts of deionized water. After the initiation of polymerization (approximately 15 minutes), the residual monomer mixture was added in the course of 3.5 hours, whilst simultaneously a solution of 0.06 parts of ammonium peroxodisulfate in 5.7 parts of water was metered in parallel. The reaction temperature was held at 70 to 72° C. for this time. After the end of the feeds, 0.06 parts of ammonium peroxodisulfate in 5.7 parts of water were added and then polymerization was continued to exhaustion for 1 hour up to approximately 90° C. For reduction of the residual monomers, in the cooling phase, polymerization was continued to exhaustion by addition of 0.1 parts of 30% strength hydrogen peroxide (at 80° C.) and 0.26 parts of ascorbic acid (at 75° C.). This produced a coagulate-free dispersion of solids content 45%, a residual vinyl acetate content of 0.07% and a viscosity of 21 800 mPa·s (Brookfield RVT, spindle 6, 20 rpm, 23° C.). The pH was 2.5.

Dispersion B

The production was performed in a similar manner to dispersion A with the difference that, as protective colloid, instead of 3.5 parts of ®Mowiol 40-88 and 3.5 parts of ®Mowiol 26-88, this time 3.5 parts of ®Mowiol 40-88, 3.25 parts of ®Mowiol 26-88 and 0.25 parts of ®Tylose H₂O (low-molecular-weight hydroxyethylcellulose from Shin-Etsu Chemical Co., Ltd.) were used. This produced a coagulate-free dispersion of solids content 45%, a residual vinyl acetate content of 0.11%, and a viscosity of 21 700 mPa·s (Brookfield RVT, spindle 6, 20 rpm, 23° C.). The pH was 2.5.

Dispersion C

The production was performed in a similar manner to dispersion A with the difference that, as protective colloid, instead of 3.5 parts of ®Mowiol 40-88 and 3.5 parts of ®Mowiol 26-88, this time 5.0 parts of ®Mowiol 26-88 and 2.0 parts of ®Tylose H₂O were used. This produced a coagulate-free dispersion of solids content 45%, a residual vinyl acetate content of 0.09% and a viscosity of 24 400 mPa·s (Brookfield RVT, spindle 6, 20 rpm, 23° C.). The pH was 2.5.

Dispersion D

The production was performed in a similar manner to dispersion A with the difference that, as protective colloid, instead of 3.5 parts of ®Mowiol 40-88 and 3.5 parts of ®Mowiol 26-88, this time 5.0 parts of ®Mowiol 26-88 and 2.0 parts of ®Tylose C30 (low molecular weight sodium carboxymethylcellulose from Shin-Etsu Chemical Co., Ltd.) were used. This produced a coagulate-free dispersion of solids content 45%, a residual vinyl acetate content of 0.18% and a viscosity of 11 500 mPa·s (Brookfield RVT, spindle 6, 20 rpm, 23° C.). The pH was 3.9.

Determination of the Natamycin Recovery Rate using HPLC

The following method was used to determine the content of active natamycin in the examples described hereinafter:

0.2-1 g of the dispersion sample was weighed out accurately into a 50 ml measuring flask and made up to mark with methanol. The sample was shaken well and treated for 15 min in the ultrasonic bath. The sample was then centrifuged for 20 min at 15 500 rpm. The HPLC determination was performed using the Partisil 5 C8 column as stationary phase and 80 methanol/20 water/1 acetic acid as mobile phase. The injection volume was 5 μl. The standard consisted of ®Delvocid from DSM Food Specialities (consists of 50% active natamycin). Detection was performed by means of UV at 303 nm in the concentration range of 2-10 mg/l against the pure standard (concentration 2 mg/l).

Determination of the Ascorbic Acid Concentration

This was performed using Merckoquant test sticks from Merck (according to the manufacturer's details, the concentration range which can be determined is between 50-2000 mg/l)

### EXAMPLE 1

Dispersion A was set to a pH of 4.8 using 15% strength potassium hydroxide solution and admixed with 200 mg of ascorbic acid per kg of dispersion.

Determination of ascorbic acid concentration found a value of 200 ppm.

### EXAMPLE 2

Dispersion B was set to a pH of 4.8 using 15% strength potassium hydroxide solution and admixed with 200 mg of ascorbic acid per kg of dispersion. Determination of the ascorbic acid concentration found a value of 200 ppm.

### EXAMPLE 3

Dispersion A was set to a pH of 4.8 using 15% strength potassium hydroxide solution. No antioxidant was added.

### EXAMPLE 4

Dispersion B was set to a pH of 4.8 using 15% strength potassium hydroxide solution. No antioxidant was added.

### COMPARATIVE EXAMPLE C1

Dispersion C was set to a pH of 4.8 using 15% strength potassium hydroxide solution. No antioxidant was added.

### COMPARATIVE EXAMPLE C 2

Dispersion C was set to a pH of 4.8 using 15% strength potassium hydroxide solution and admixed with 200 mg of ascorbic acid per kg of dispersion. Determination of the ascorbic acid concentration found a value of 200 ppm.

### COMPARATIVE EXAMPLE C 3

Dispersion D was set to a pH of 4.8 using 15% strength potassium hydroxide solution. No antioxidant was added.

The natamycin recovery rate was determined for all examples and comparative examples. This was carried out as duplicate determination. For this, in each case two aliquots of the product were taken and each was admixed with 300 ppm of an aqueous suspension of natamycin using a disposable pipette with stirring. For determining the percentage recovery rate, first, its initial concentration was determined immediately after addition of natamycin to each sample. Then, the samples were subjected to a one-week storage at 40° C. in the warm cabinet and the final concentration was determined. The percentage recovery rates are reported in the form of the means of the duplicate determinations (accuracy ±1%) and are shown in the table hereinafter.

| | | | Ascorbic acid | Natamycin |
|---|---|---|---|---|
| | | Cellulose ether | concentration | recovery |
| Example | pH | [% on monomer] | [ppm] | 7 days 40° C. [%] |
| 1 | 4.8 | — | 200 | 94 |
| 2 | 4.8 | — | — | 89 |
| 3 | 4.8 | 0.25% HEC | 200 | 97 |
| 4 | 4.8 | 0.25% HEC | — | 90 |
| C1 | 4.8 | 2% HEC | — | 84 |
| C2 | 4.8 | 2% HEC | 200 | 91 |
| C3 | 4.8 | 2% NaCMC | — | 80 |

The inventive examples 1 and 3 of variant I of the composition having reduced fractions of cellulose ether and supplemented ascorbic acid give recovery rates of significantly above 90%.

The inventive examples 2 and 4 of the variant 11 of the composition which have no stabilizing antioxidant likewise show high recovery rates.

The non-inventive comparative examples C1 to C3 illustrate the adverse effect of high fractions of cellulose ether on the recovery rates which become higher at a reduced fraction of this component.

1. An aqueous polymer dispersion which is set to a pH range of 4 to 6 and comprises
A) 100 parts by weight of a homopolymer or copolymer produced by emulsion polymerization,
B) 0.1 to 15 parts by weight, based on the total amount of the monomers used, of at least one protective colloid,
C) 0.1 to 10 parts by weight, based on the total amount of the monomers used, of at least one nonionic emulsifier,
D) 10 to 990 ppm by weight, based on the mass of the total dispersion of at least one antioxidant, and
E) at least one polyene fungicide,
with the proviso that the protective colloid contains no cellulose ether, or up to 0.45 parts by weight of cellulose ether, based on the total amount of the monomers used.

2. An aqueous polymer dispersion which is set to a pH range of 4.5 to 5.5 and comprises
A) 100 parts by weight of a homopolymer or copolymer produced by emulsion polymerization,
B) 0.1 to 15 parts by weight, based on the total amount of the monomers used, of at least one protective colloid,
C) 0.1 to 10 parts by weight, based on the total amount of the monomers used, of at least one nonionic emulsifier, and
E) at least one polyene fungicide,
with the proviso that the polymer dispersion is free of antioxidant and that the protective colloid has no cellulose ether, or up to 0.45 part by weight of cellulose ether, based on the total amount of the monomers used.

3. An aqueous polymer dispersion as claimed in claim 1, wherein component B) has at most 0.3 parts by weight, based on the total amount of the monomers used, of cellulose ether.

4. An aqueous polymer dispersion as claimed in claim 1, wherein the amount of component D) is 50 to 900 ppm based on the mass of the total dispersion.

5. An aqueous polymer dispersion as claimed in claim 1, wherein component A) is derived from homopolymers or copolymers selected from the group consisting of
A1) copolymer of the vinyl esters of aliphatic, saturated carboxylic acids, preferably fatty acids having a chain length of C₁-C₁₈, and maleic esters and/or fumaric esters of monohydric aliphatic alcohols having a chain length of C₁-C₁₈,
A2) homopolymer or copolymer of vinyl esters of aliphatic, saturated carboxylic acids,
A3) copolymer of vinyl esters of aliphatic, saturated carboxylic acids and
A4) homopolymer or copolymer of (meth)acrylic acid alkyl esters having 1 to 18 carbon atoms in the alkyl chain, or a copolymer of these (meth)acrylic acid alkyl esters having any combinations of the monomers specified under A1) to A3).

6. An aqueous polymer dispersion as claimed in claim 5, wherein component A) comprises a copolymer of group A1).

7. An aqueous polymer dispersion as claimed in claim 6, wherein component A) is derived from a vinyl ester of aliphatic fatty acids.

8. An aqueous polymer dispersion as claimed in claim 1, wherein component B) comprises poly(vinyl alcohol).

9. An aqueous polymer dispersion as claimed in claim 1, wherein component C) comprises acyl, alkyl, oleyl and/or alkylaryl oxethylates.

10. An aqueous polymer dispersion as claimed in claim 1, wherein no other ionic emulsifiers in addition to nonionic emulsifiers C) are present.

11. An aqueous polymer dispersion as claimed in claim 1, wherein component D) is ascorbic acid, isoascorbic acid, tartaric acid, citric acid, alkali metal or alkaline earth metal salts of these acids, gluconic acid, ascorbyl palmitate, ascorbyl stearate, butylated hydroxyanisole, butylated hydroxytoluene, alpha-tocopherol, gamma-tocopherol or delta-tocopherol, retinol, propyl, octyl or dodecyl gallate or mixtures of two or more of these compounds.

12. An aqueous polymer dispersion as claimed in claim 1, wherein component E) comprises natamycin.

13. An aqueous polymer dispersion as claimed in claim 1, wherein the amount of component E) is 100 to 500 ppm based on the mass of the total dispersion.

14. An aqueous polymer dispersion which is set to a pH range of 4 to 6 comprising
A) 100 parts by weight of a homopolymer or copolymer produced by emulsion polymerization,
B) 0.1 to 15 parts by weight, based on the total amount of the monomers used, of at least one protective colloid,
C) 0.1 to 10 parts by weight, based on the total amount of the monomers used, of at least one nonionic emulsifier, and
D) 10 to 990 ppm by weight, based on the mass of the total dispersion, of at least one antioxidant,
with the proviso that the protective colloid has no cellulose ether, or up to 0.45 part by weight of cellulose ether, based on the total amount of the monomers used.

15. A process for producing aqueous polymer dispersions as claimed in claim 1 comprising the steps:
i) free-radical emulsion polymerization of at least one ethylenically unsaturated monomer for producing a homopolymer or copolymer A) in the presence of
ii) 0.1 to 15 parts by weight, of at least one protective colloid and
iii) 0.1 to 10 parts by weight of at least one nonionic emulsifier,
iv) optionally addition of at least one antioxidant in an amount such that the concentration of antioxidant in the polymer dispersion is 10-990 ppm by weight, based on the mass of the total dispersion,
v) optionally setting the resultant aqueous polymer dispersion to a pH range between 4 and 6,
vi) optionally addition of further additives F) suitable for coating foods, and
vii) addition of polyene fungicide E),
with the proviso that the protective colloid used has no cellulose ether, or up to 0.45 part by weight of cellulose ether, based on the total amount of the monomers used.

16. A process for producing aqueous polymer dispersions as claimed in claim 2 comprising the steps:
i) free-radical emulsion polymerization of at least one ethylenically unsaturated monomer for producing a homopolymer or copolymer A) in the presence of
ii) 0.1 to 15 parts by weight of at least one protective colloid B), and
iii) 0.1 to 10 parts by weight of at least one nonionic emulsifier C),
iv) optionally addition of at least one antioxidant in an amount such that the content of unreacted monomers and/or oxidizing components in the polymer dispersion is decreased with reduction of the amount of antioxidant,
v) optionally setting the resultant aqueous polymer dispersion to a pH range between 4.5 and 5.5,
vi) optionally addition of further additives F) suitable for coating foods, and
vii) addition of polyene fungicide E),
with the proviso that the amount of antioxidant is chosen such that the polymer dispersion, after carrying out step iv) is free from antioxidants and that the protective colloid used has no cellulose ether, or up to 0.45 part by weight of cellulose ether, based on the total amount of the monomers used.

17. A coating and/or packaging food which comprises the aqueous polymer dispersion as claimed in claim 1.

18. The coating and/or packaging food as claimed in claim 16 which is used as a coating cheese.

19. An aqueous polymer dispersion as claimed in claim 1, wherein component A) is derived from homopolymers or copolymers selected from the group consisting of
A1) copolymer of the vinyl esters of aliphatic, saturated carboxylic acids, preferably fatty acids having a chain length of C₁-₁₈, and maleic esters and/or fumaric esters of monohydric aliphatic alcohols having a chain length of C₁-₁₈,
A2) homopolymer or copolymer of fatty acids having a chain length of C₁-₁₈,
A3) copolymer of fatty acids having a chain length of C₁-₁₈ and ethylene, and
A4) homopolymer or copolymer of (meth)acrylic acid alkyl esters having 1 to 18 carbon atoms in the alkyl chain, or a copolymer of these (meth)acrylic acid alkyl esters having any combinations of the monomers specified under A1) to A3),
component B) comprises poly(vinyl alcohol) and has no cellulose ether,
component C) comprises acyl, alkyl, oleyl and/or alkylaryl oxethylates,
the amount of component D) is 100 to 350 ppm based on the mass of the total dispersion and
component D) is ascorbic acid, isoascorbic acid, tartaric acid, citric acid, alkali metal or alkaline earth metal salts of these acids, gluconic acid, ascorbyl palmitate, ascorbyl stearate, butylated hydroxyanisole, butylated hydroxytoluene, alpha-tocopherol, gamma-tocopherol or delta-tocopherol, retinol, propyl, octyl or dodecyl gallate or mixtures of two or more of these compounds and
component E) comprises natamycin and wherein the amount of component E) is 150 to 350 ppm based on the mass of the total dispersion.

20. An aqueous polymer dispersion as claimed in claim 2, wherein component A) is derived from homopolymers or copolymers selected from the group consisting of
A1) copolymer of the vinyl esters of aliphatic, saturated carboxylic acids, preferably fatty acids having a chain length of C₁-C₁₈, and maleic esters and/or fumaric esters of monohydric aliphatic alcohols having a chain length of C₁-C₁₈,
A2) homopolymer or copolymer of fatty acids having a chain length of C₁-C₁₈,
A3) copolymer of fatty acids having a chain length of C₁-C₁₈ and ethylene, and
A4) homopolymer or copolymer of (meth)acrylic acid alkyl esters having 1 to 18 carbon atoms in the alkyl chain, or a copolymer of these (meth)acrylic acid alkyl esters having any combinations of the monomers specified under A1) to A3),
component B) comprises poly(vinyl alcohol) and has no cellulose ether,
component C) comprises acyl, alkyl, oleyl and/or alkylaryl oxethylates, and
component E) comprises natamycin and wherein the amount of component E) is 150 to 350 ppm based on the mass of the total dispersion.

21. A process for producing aqueous polymer dispersions as claimed in claim 1 comprising the steps:
i) free-radical emulsion polymerization of at least one ethylenically unsaturated monomer for producing a homopolymer or copolymer A) in the presence of
ii) 0.2 to 10 parts by weight, of at least one poly(vinyl alcohol), and
iii) 0.1 to 3 parts by weight of at least one nonionic emulsifier,
iv) optionally addition of at least one antioxidant in an amount such that the concentration of antioxidant in the polymer dispersion is 10-990 ppm by weight, based on the mass of the total dispersion,
v) optionally setting the resultant aqueous polymer dispersion to a pH range between 4 and 6,
vi) optionally addition of further additives F) suitable for coating foods, and
vii) addition of polyene fungicide E),
with the proviso that the protective colloid used has no cellulose ether, or up to 0.45 part by weight of cellulose ether, based on the total amount of the monomers used.

22. A process for producing aqueous polymer dispersions as claimed in claim 2 comprising the steps:
i) free-radical emulsion polymerization of at least one ethylenically unsaturated monomer for producing a homopolymer or copolymer A) in the presence of
ii) 0.2 to 10 parts by weight of at least one poly(vinyl alcohol) and
iii) 0.1 to 3 parts by weight of at least one nonionic emulsifier C),
iv) optionally addition of at least one antioxidant in an amount such that the content of unreacted monomers and/or oxidizing components in the polymer dispersion is decreased with reduction of the amount of antioxidant,
v) optionally setting the resultant aqueous polymer dispersion to a pH range between 4.5 and 5.5,
vi) optionally addition of further additives F) suitable for coating foods, and
vii) addition of polyene fungicide E),
with the proviso that the amount of antioxidant is chosen such that the polymer dispersion, after carrying out step iv) is free from antioxidants and that the protective colloid used has no cellulose ether, or up to 0.45 part by weight of cellulose ether, based on the total amount of the monomers used.
